(19) United States
(12) Patent Application Publication
(10) Pub. No.: US 2004/0161230 A1
(43) Pub. Date: Aug. 19, 2004

(54) Camera

(75) Inventors: Tetsuo Hosokawa, Tokyo (JP); Takuya Hasegawa, Tokyo (JP); Mikio Ogi, Kouchi-Ken (JP); Yoshinori Ono, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/778,212

(22) Filed: Feb. 17, 2004

(30) Foreign Application Priority Data
Feb. 18, 2003 (JP) P2003-039946

(51) Int. Cl. G03B 15/03

(52) U.S. Cl. 396/177

(57) ABSTRACT

A first motor is provided adjacent to a spool. The rotational force of the first motor can be transmitted to the spool through a gear train and can be transmitted to an up-down operating mechanism of the flash case through a cam gear. The change of the transmission path of the rotational force of the first motor is performed by a first change mechanism. The transmitting mechanism including the first change mechanism is provided at the upper side of the spool. A second motor is provide adjacent to a bottom of a cartridge room. The rotational force of the second motor can be transmitted to a rewind fork in the cartridge room, and can be transmitted to a driving mechanism of a quick return mirror, a diaphragm, and a shutter. The change of the transmission path of the rotational force of the second motor is performed by a second change mechanism.

### BACKGROUND OF THE INVENTION

1. Field of the Invention

The present invention relates to a camera.

2. Description of the Related Art

Conventionally, in a camera in which a silver salt film is mounted for photographing, the film is fed by a single driving system (a film motor) When the film is wound, a spool which is provided in a spool room, is rotated in a direction by a film motor in the spool, and the film in a cartridge which is mounted in a cartridge room is fed in the direction of the spool room. When the film is rewound, the film motor is rotated in the reverse direction of the film winding, the rotation is transmitted to a rewind fork in the cartridge room through a gear train in which a plurality of gears are combined. Accordingly, the film wound in the spool room is fed in the direction of the cartridge room so as to be put back in the cartridge.

Generally, the gear train is mounted in the camera in such a manner that a plurality of gears are combined at the bottom of the camera, expanding along the width of the camera. Namely, the gear train includes a lot of members, and further has a predetermined thickness in the direction perpendicular to the direction in which the rotational force of the film motor is transmitted. Due to the structural features of the gear train, the length, in the longitudinal direction, of the camera is enlarged, and the camera is prevented from being made compact.

Recently, downsizing of cameras has become increasingly important, and silver salt cameras are also required to be much more compact.

On the other hand, there is a camera with a built-in flash. The flash is moved so as to be positioned at an operating position or a storage position. In this type of camera, it is necessary to mount an extra motor for the flash or to mount an extra mechanism for changing transmitting path of the rotation of the film motor in order to make the film motor work as the driving source of both the film and the flash. Such extra members cause difficulty in reducing the size of the camera.

### SUMMARY OF THE INVENTION

Therefore, an object of the present invention is to reduce the size of a camera.

In accordance with an aspect of the present invention, there is provided a camera comprising: a first motor which is used for a driving source for both an up-down operating mechanism of a case in which;a flash is provided, and a mechanism for winding a film; a first speed reducing mechanism which transmits a rotation of the first motor, reducing its rotating speed; and a spool which is rotated by transmitting the rotation of the first motor through the first speed reducing mechanism. The first speed reducing mechanism is situated at the upper side of said spool.

Preferably, a substrate for controlling the flash is provided at the lower side of the spool, and a capacitor which is mounted on the substrate is penetrated through the spool.

Preferably, the first speed reducing mechanism includes a first change mechanism which changes the transmission paths of the rotation of the first motor such that a rotational force, of the first motor, in a first direction is transmitted to the spool, and a rotational force, of the first motor, in a second direction opposite to the first direction is transmitted to said up-down operating mechanism.

For example, the first change mechanism includes: a pinion gear which is fixed at an output shaft of the first motor; a speed reducing gear train; a sun gear to which the rotation of the pinion gear is transmitted through the speed reducing gear train; and a planet gear which is engaged with the sun gear. When the first motor is rotated in the first direction, the planet gear is moved so as to be engaged with a gear which is engaged with a connecting gear which transmits a rotational movement to the spool, and when the first motor is rotated in the second direction, the planet gear is moved so as to be engaged with a cam gear for moving a follower pin which drives the up-down operating mechanism.

More preferably, the camera further comprises: a second motor which is used as a driving source for rewinding the film; and a second speed reducing mechanism which transmits a rotation of the second motor reducing its rotating speed. The second motor and the second speed reducing mechanism are provided at the bottom of the camera, in a space at a side of the mirror, which is opposite to a side of the mirror closest to the spool,

Usually, in a camera body of a single-lens reflex camera, as an inversion optical system, for example a penta prism, is provided at an upper side of a mirror box in order to be able to view an erected image, a dead space exists at both lateral sides of the penta prism. According to the present invention, the first speed reducing mechanism, which transmits the rotation of the first motor to the spool, is provided at the upper side of the spool. Namely, the above-mentioned dead space is effectively used. Therefore, the camera body can be made compact.

When the motor for winding the film is used for a purpose other than winding the film, the driving force of the motor is effectively used. In other words, an increase in a number of components, caused by providing a plurality of motors for feeding the film and other purposes, can be reduced. Therefore, the camera body can be made compact.

When film winding is carried out by one motor, and film rewinding is carried out by another motor, it is not necessary to provide a conventional transmitting mechanism between the film winding motor and a rewinding shaft. Accordingly, the length, of a single-lens reflex camera, in the lengthwise direction, can be shorter.

### BRIEF DESCRIPTION OF THE DRAWINGS

The objects of the present invention will be better understood from the following description, with reference to the accompanying drawings, in which:

FIG. 1 is a front view of a camera body of a single lens reflex camera to which an embodiment according to the present invention is applied;

FIG. 2 is a side view of the camera body, viewed at the right side of FIG. 1;

FIG. 3 is a front view of an inside structure of the camera body;

FIG. 4 is a plane view of the inside structure;

FIG. 5 is a bottom view of the inside structure;

FIG. 6 is a side view of the inside structure, viewed from the right side of FIG. 3;

FIG. 7 is a plane view of a gear structure of a first speed reducing mechanism when the rotation of a first motor is transmitted to a spool;

FIG. 8 is a plane view of a gear structure of the first speed reducing mechanism when the rotation of the first motor is transmitted to an up-down operating mechanism of a flash case;

FIG. 9 is a plane view of a cam gear and a rotating lever of the up-down operating mechanism of the flash case;

FIG. 10 is a plane view of the rotating lever, a rotating arm, and a press spring of the up-down operating mechanism;

FIG. 11 is a perspective view of the rotating lever, the rotating arm, and the press spring;

FIG. 12 is as device of the rotating arm of the up-down operating mechanism and the flash case;

FIG. 13 is a side view which shows the motion of the rotating arm of the up-down operating mechanism and the flash case;

FIG. 14 is a plane view of the cam gear and the rotating lever of the up-down operating mechanism when the flash case is positioned at a middle position between an up position and a down position;

FIG. 15 is a plane view of the cam gear and the rotating lever of the up-down operating mechanism when the flash case is positioned at the up position;

FIG. 16 is an enlarged front view of a second speed reducing mechanism;

FIG. 17 is an enlarged view of the second speed reducing mechanism, where some components are omitted;

FIG. 18 is a perspective view of the second speed reducing mechanism;

FIG. 19 is a side view of the second speed reducing mechanism; viewed from the left side of FIG. 16;

FIG. 20 is an enlarged front view of a second change mechanism, showing that a solenoid is electrically energized, and a planet gear is positioned such that the rotation of a second motor is transmitted to a shutter charge lever, a diaphragm control lever, and a mirror driving lever;

FIG. 21 is an enlarged front view of the second change mechanism, showing that the solenoid is electrically energized, and the planet gear is positioned such that the rotation of the second motor is transmitted to a rewind fork;

FIG. 22 is an enlarged front view of the second change mechanism, showing that the solenoid is electrically deenergized, and the planet gear is positioned such that the rotation of the second motor is transmitted to the rewind fork;

FIG. 23 is a perspective view which shows a gear train of the second speed reducing mechanism and a gear train for rewinding a film, when the film is rewound;

FIG. 24 is a perspective view which shows the gear train of the second speed reducing mechanism and a shutter driving mechanism, and a mirror driving mechanism, when either a photographing operation or a preview operation is performed; and

FIG. 25 is a view which shows the planet gear and the diaphragm control lever.

### DESCRIPTION OF THE PREFERRED EMBODIMENTS

The present invention will now be described with reference to an embodiment shown in the drawings.

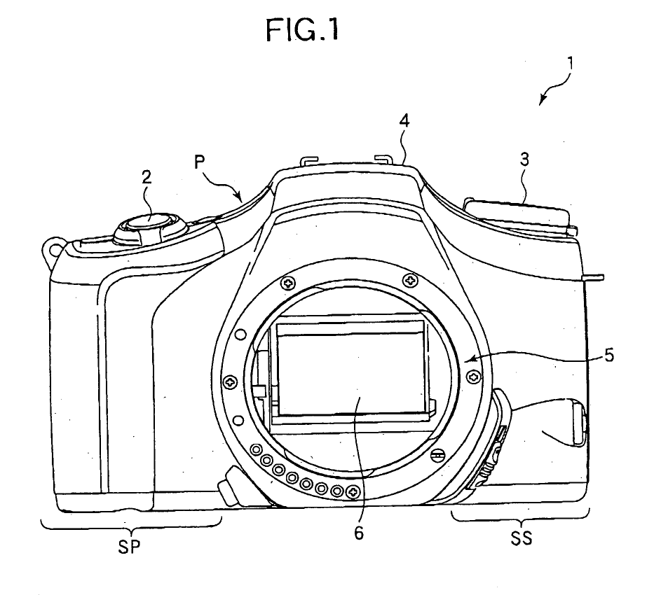

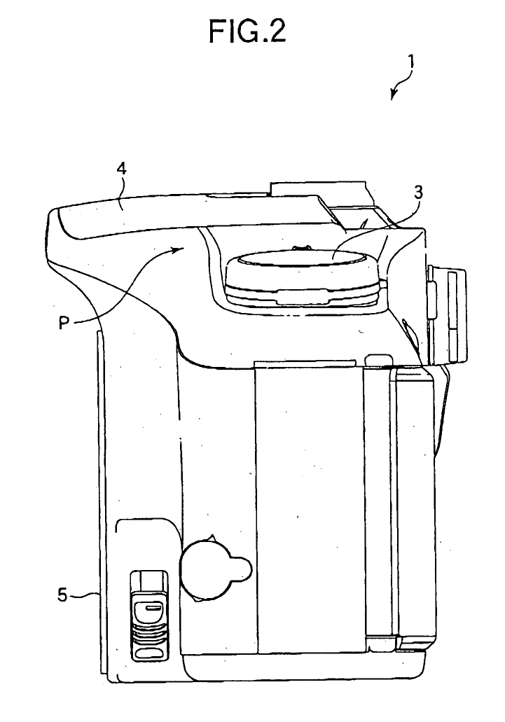

FIG. 1 is a front view of a camera body 1 of a single lens reflex camera to which an embodiment according to the present invention is applied. FIG. 2 is a side view of the camera body 1, viewed from the right side of FIG. 1.

An upper casing plate P is placed on the upper side of the camera body 1. A release button 2 is provided on the plate P, being positioned at the left side in FIG. 1. A setting dial 3 for setting various modes is provided on the plate P, being position at the right side in FIG. 1. A flash case 4 15 is positioned at the center of the plate P. A flash (not shown) is built in the flash case 4, being positioned at the front side end of the camera body 1. The flash case 4 is rotatably supported by a shaft which is provided at the back side end of the camera body 1. When the flash is not used, the flash case 4 is held at a storage position as shown in FIG. 1. When the flash is used, the flash case 4 is rotated around the above-mentioned shaft, the front side end in which the flash is built is moved upwardly, and the flash case 4 is held in an operating position. A lens mount 5 is provided at the center of the camera body 1. A quick return mirror 6 is provided in the camera body 1, being on an optical axis of a lens barrel which is mounted on the lens mount 5.

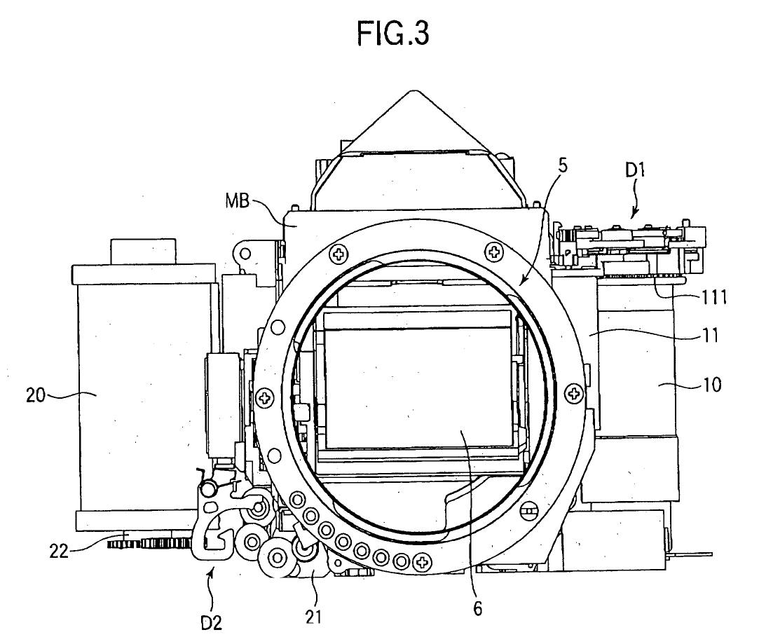

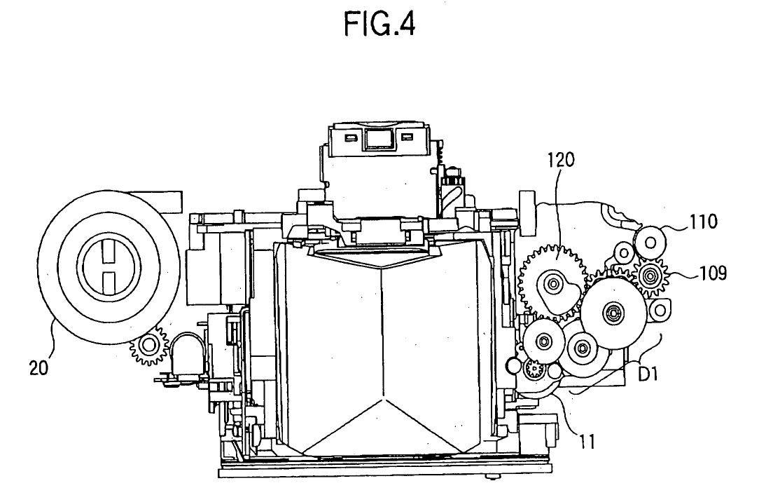

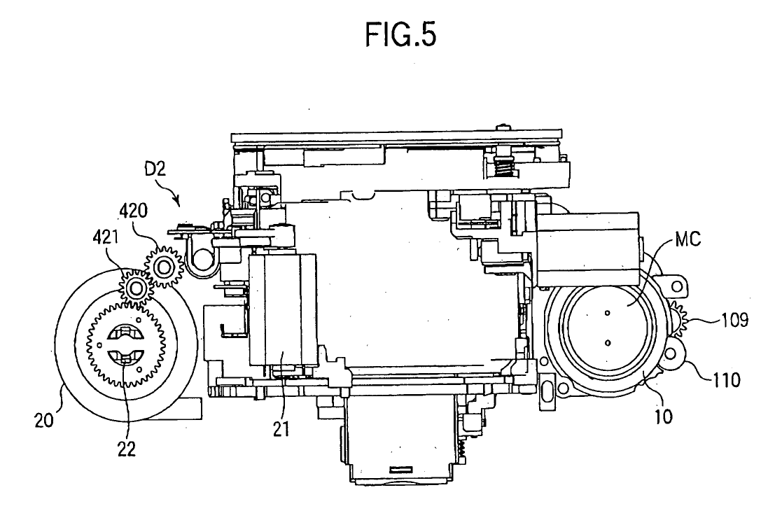

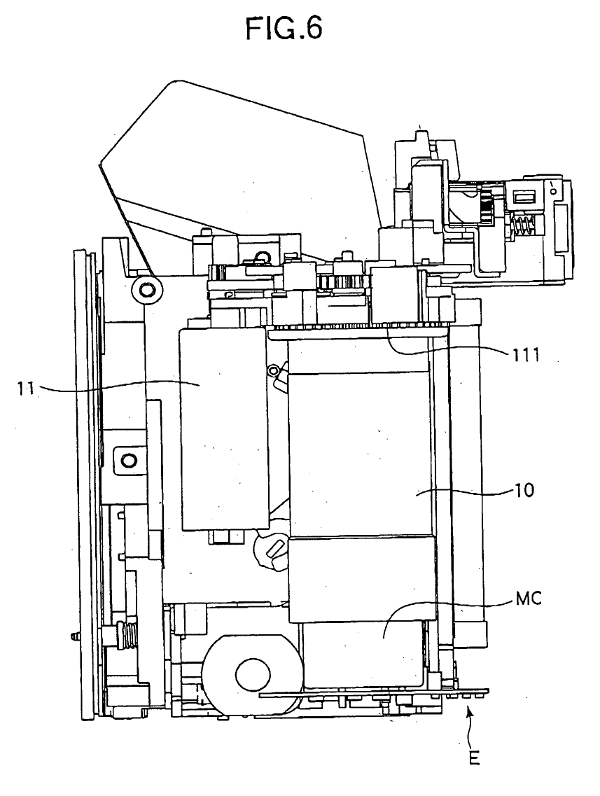

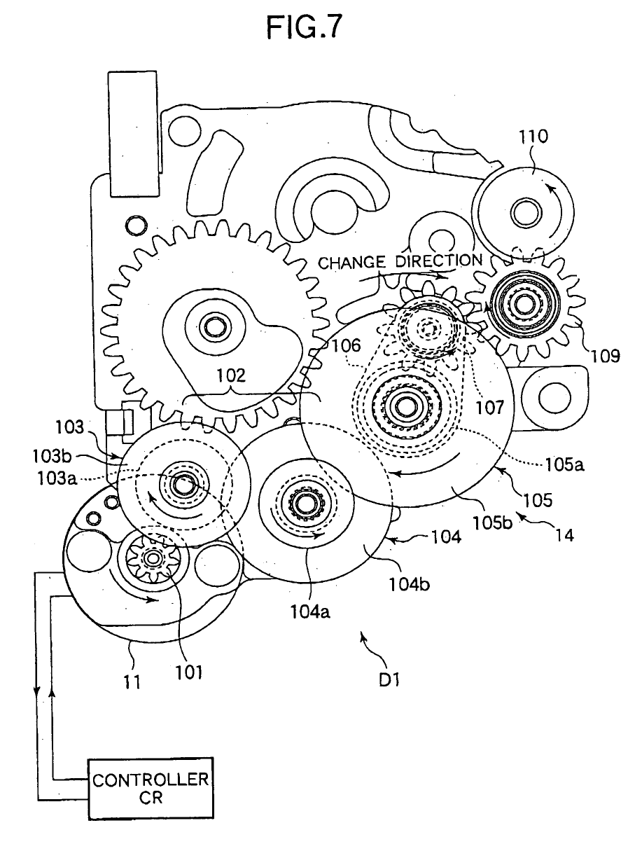

FIG. 3 is a front view of an inside structure of the camera body 1, FIG. 4 is a plane view of the inside structure, FIG. 5 is a bottom view of the inside structure, and FIG. 6 is a side view of the inside structure, viewed from the right side of FIG. 3. A first motor 11 is provided adjacent to a spool 10. The rotation of the first motor 11 is optionally transmitted to, an up-down mechanism of the flash or the spool 10, through a first speed reducing mechanism D1. The transmission of the rotation of the first motor 11 to the spool 10 is performed through a friction gear 109, a connecting gear 110, and a spool gear 111 of the spool 10. Further, the rotation of the first motor 11 is transmitted to the up-down mechanism of the flash, namely the driving mechanism of the flash case 4, through a cam gear 120. With respect to the rotation of the first motor 11, a first change mechanism 14 (see FIG. 7) of the first speed reducing mechanism D1 changes the transmission of the rotational force between the spool 10 and the up-down mechanism. A second motor 21 is provided adjacent to the bottom of the cartridge room 20. A controller CR (see FIG. 7) controls the start and stop of rotation and the rotational directions of the first motor 11 and the second motor 21. Note that, the first change mechanism 14 and the controller CR are explained later.

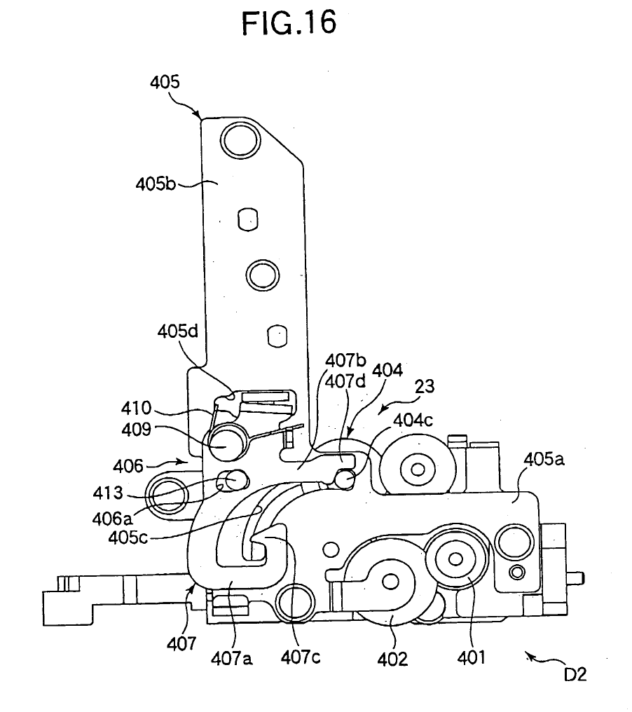

The rotation of the second motor 21 is transmitted to a rewinding fork 22 of the cartridge room 20 and driving mechanisms of the quick return mirror 6, a diaphragm (not shown) and a shutter (not shown) With respect to the rotation of the second motor 12, a second change mechanism 23 (see FIG. 16) of a second transmitting mechanism D2 changes the transmission of the rotational force between the rewinding fork 22 and the driving mechanisms. Note that, the second change mechanism 23 is explained later.

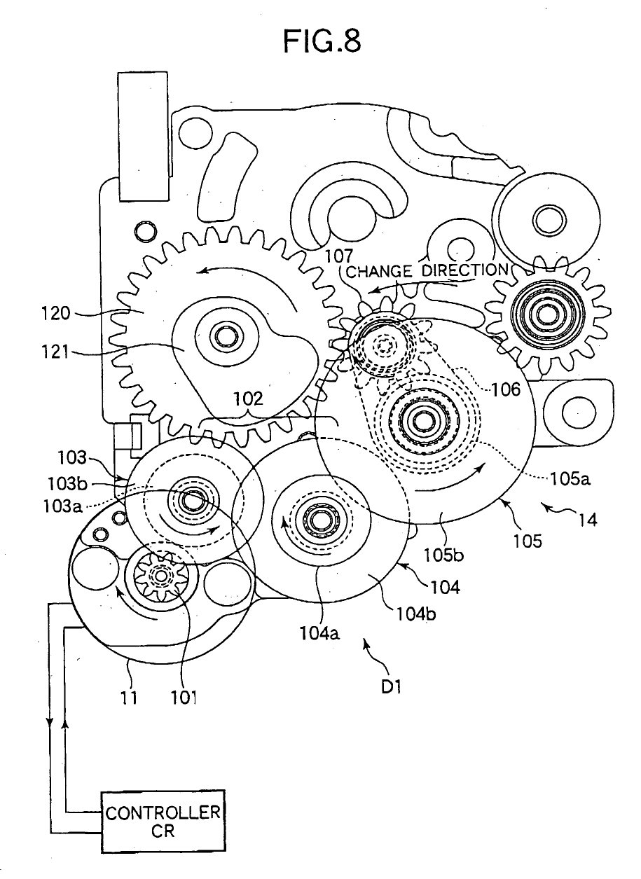

FIGS. 7 and 8 are plane views of the structure of the first speed reducing mechanism D1. In the first mechanism D1, a pinion gear 101 is fixed at the output shaft of the first motor 11. A speed reduction gear train 102 includes first and second reduction gears 103 and 104. The reduction gear 103 includes a small-diameter gear 103a and a large-diameter gear 103b which are unitarily formed, being coaxial. Similarly, the reduction gear 104 includes a small-diameter gear 104a and a large-diameter gear 104b which are unitarily formed, being coaxial. The pinion gear 101 is engaged with the gear 103b of the reduction gear 103, and the gear 103a of the reduction gear 103 is engaged with the gear 104b of the reduction gear 104.

A sun gear 105 includes a small-diameter gear 105a and a large-diameter gear 105b which are unitarily formed, being coaxial. The gear 105b is engaged with the gear 104a of the reduction gear 104. Namely, the rotation of the first motor 11 is decelerated at a predetermined speed reduction ratio and is transmitted to the sun gear 105.

A rotating plate 106 is pivoted by the rotating shaft of the sun gear 105. A planet gear 107 is rotatably provided at the end of the rotating plate 106, being engaged with the small-diameter gear 105a of the sun gear 105. The rotating plate 106 and the planet gear 107 are elements of the first change mechanism 14.

When the first motor 11 is rotated in the reverse direction (the counterclockwise direction in FIG. 7), the rotation is transmitted to the sun gear 105 through the pinion gear 101 and the speed reduction gear train 102, and the sun gear 105 is rotated in the clockwise direction. As shown in FIG. 7, in accordance with the rotation of the sun gear 105 in the clockwise direction, the rotating plate 106 is rotated in the clockwise direction around the center shaft of the sun gear 105. Due to the rotation of the rotating plate 106, the planet gear 107 is moved to be engaged with a friction gear 109.

The friction gear 109 is engaged with the connection gear 110. The connection gear 110 is engaged with the spool gear 111 (see FIGS. 3 and 6), which is coaxial with the central axis of the rotation of the spool 10. Accordingly, while the first motor 11 is rotating, the rotation of the first motor 11 is transmitted to the spool 10 through the pinion gear 101, the speed reduction gear train 102, the sun gear 105, the planet gear 107, the friction gear 109, the connection gear 110, and the spool gear 111, so that the film is wound.

When the first motor 11 is rotated in the forward direction (the clockwise direction in FIG. 8), the rotation is transmitted to the sun gear 105 through the pinion gear 101 and the speed reduction gear train 102, and the sun gear 105 is rotated in the counterclockwise direction. As shown in FIG. 8, in accordance with the rotation of the sun gear 105 in the counterclockwise direction, the rotating plate 106 is rotated in the counterclockwise direction around the central shaft of the sun gear 105. Due to the rotation of the rotating plate 106, the planet gear 107 is engaged with the cam gear 120.

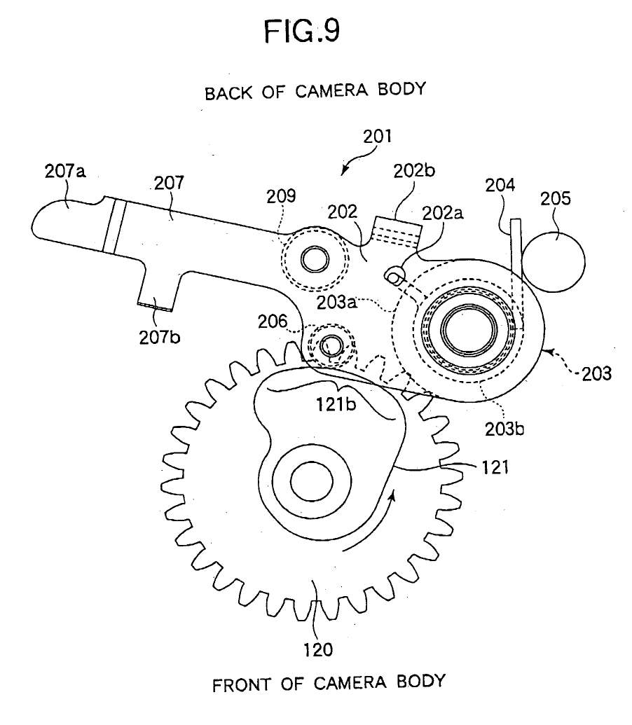

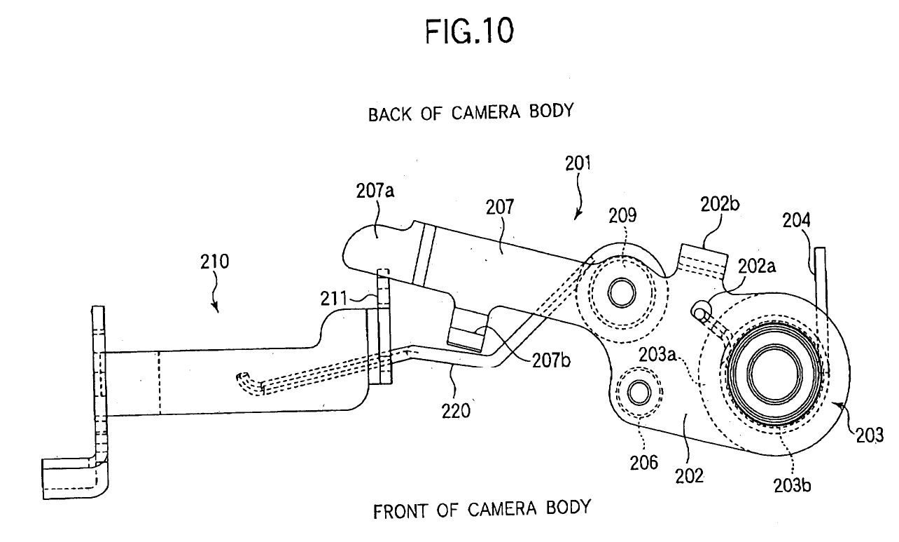

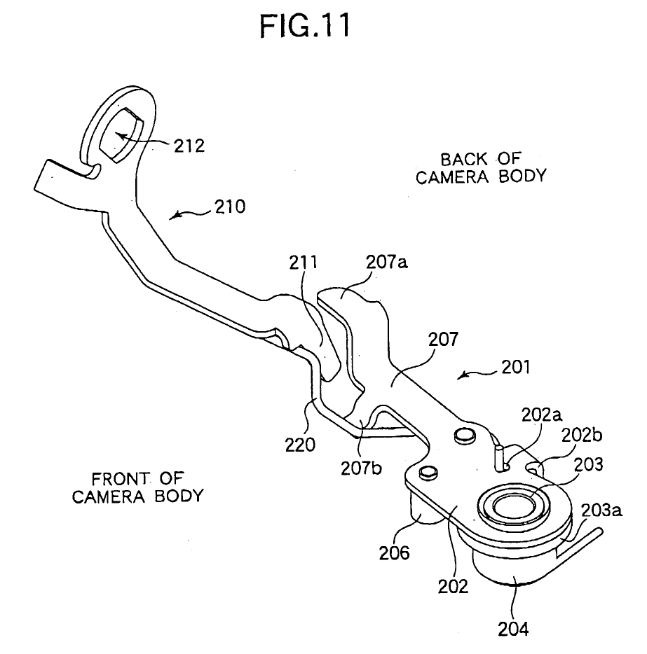

FIG. 9 is a plane view which shows the cam gear 120 and a rotating lever 201. FIG. 10 is a plane view which shows the rotating lever 201, a rotating arm 210, and a press spring 220, and FIG. 11 is a perspective view of the lever 201, the arm 210, and the spring 220. The lever 201, the arm 210, and the spring 220 are members which compose an up-down mechanism of the flash case 4. Note that, in FIG. 9, a side at which the cam gear 120 is positioned corresponds to the front side of the camera body 1.

A rotating shaft 203 is provided at a base portion 202 of the rotating lever 201 in such a manner that the shaft 203 is positioned on the plane opposite to the first speed reducing mechanism D1. The rotating lever 201 is rotatably supported by the shaft 203. The shaft 203 includes a large diameter 5 portion 203-a and a small diameter portion 203b. A pop-up spring 204 is wound around the outer surface-of the portion 203b. As shown in FIG. 9, one end of the pop-up spring 204 is in contact with a pin 205 which is fixedly provided on the inner surface of the camera body 1, and another end of the spring 204 is penetrated through a hole 202a which is formed at the base portion 202. The pop-up spring 204 urges the rotating lever 201 in the counterclockwise direction in FIGS. 9 and 10, at all times. Namely, the lever 201 is urged by the pop-up spring 204 from the back side to the front side of the camera body 1.

Similar to the shaft 203, a cam follower 206, which is cylindrical, is fixedly provided at the base portion 202. An arm engaging piece 207a and a spring engaging piece 207b are formed at an engaging portion 207 of the rotating lever 201. The rotating arm 210 is engaged with the arm engaging piece 207a. The press spring 220 is engaged with the spring engaging piece 207b. Further, a supporting pin 209, which is cylindrical, is provided adjacent to the cam follower 206 at the base portion 202 of the lever 201, in such a manner that the pin 209 is projected to the first change mechanism 14.

As shown in FIGS. 10 and 11, an engaging piece 211 is formed at one end of the rotating arm 210. The engaging piece 211 is engaged with the arm engaging piece 207a of the rotating lever 201 and one end of the press spring 220. Further, as shown in FIG. 11, an engaging hole 212 is formed at another end of the rotating arm 210. A cases haft 301 (described later) of the flash case 4 is engaged with the hole 212.

The press spring 220 which is a wirelike member is wound around the pin 209 of the base 202 of the rotating lever 201. Another end of the press spring 220 is in contact with the piece 202b formed on the base 202, being securely engaged. There is a straight portion between the above-mentioned one end and the part wound a round the pin 209. The straight portion is bent at two points at predetermined angles. The part of the straight portion, between the two bent points, is engaged with the piece 207b. Further, the straight portion continues to the above-mentioned one end which is engaged with the engaging piece 211 as described above. As shown in FIG. 11, the engaging piece 211 of the rotating arm 210 is between the press spring 220 and the piece 207a of the rotating lever 201.

As shown in FIG. 9, a cam 121 is provided on a plane, which faces the rotating lever 201, of the cam gear 120. The cam 121 is a wall-like member which has a predetermined height, including a straight portion and several curved portions which have different centers of curvature When the cam 121 is moved in accordance with the rotation of the cam gear 120, the cam follower 206 is moved along the outline of the cam 121.

Accordingly, the rotating lever 201 is rotated around the rotating shaft 203.

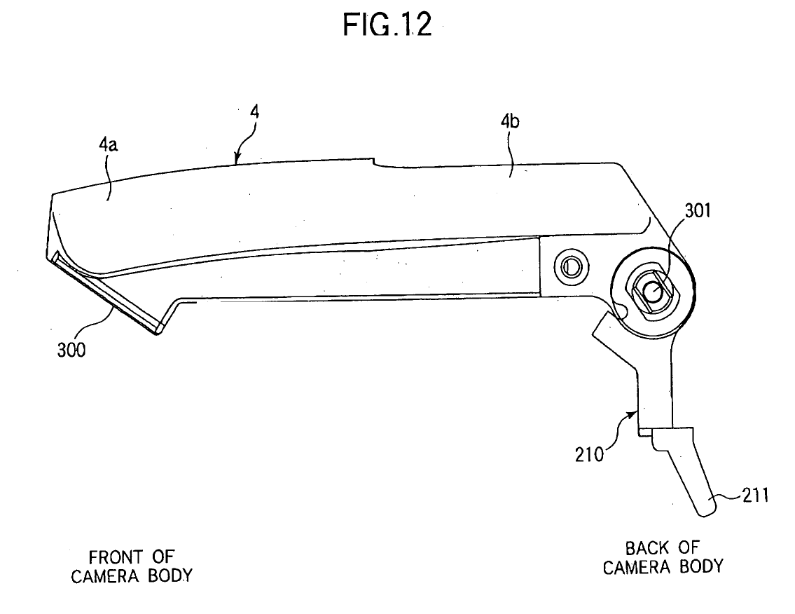

FIG. 12 is a side view which shows the rotating arm 210 and the flash case 4. The flash case 4 includes a head portion 4a and a pair of leg portions 4b. These portions are unitarily formed. A flash light emitting unit 300 is provided in the head portion 4a. The flash case 4 is situated in such a manner that the head 4a is positioned at the front side of the camera body land the pair of leg portions 4b are positioned at the back side of the camera body 1. The case shaft 301 is fixed at one of the pair of legs portions 4b. The shaft 301 is fixedly engaged with the engaging hole 212 (see FIG. 11) of the rotating arm 210, being caulked. Accordingly, the flash case 4 is rotated in accordance with the rotation of the rotating arm 210.

As described above, when the first motor 11 is rotated in the forward direction, the planet gear 107 is moved to be engaged with the cam gear 120. When the first motor 11 keeps rotating in this situation, the rotation of the first motor 11 is transmitted to the cam gear 120, so that the cam gear 120 keeps rotating in the counterclockwise direction in FIG. 8. In accordance with the rotation of the cam gear 120, the rotating lever 201 is rotated around the rotating shaft 203 through the cam 121 and the cam follower 206 (see FIG. 9).

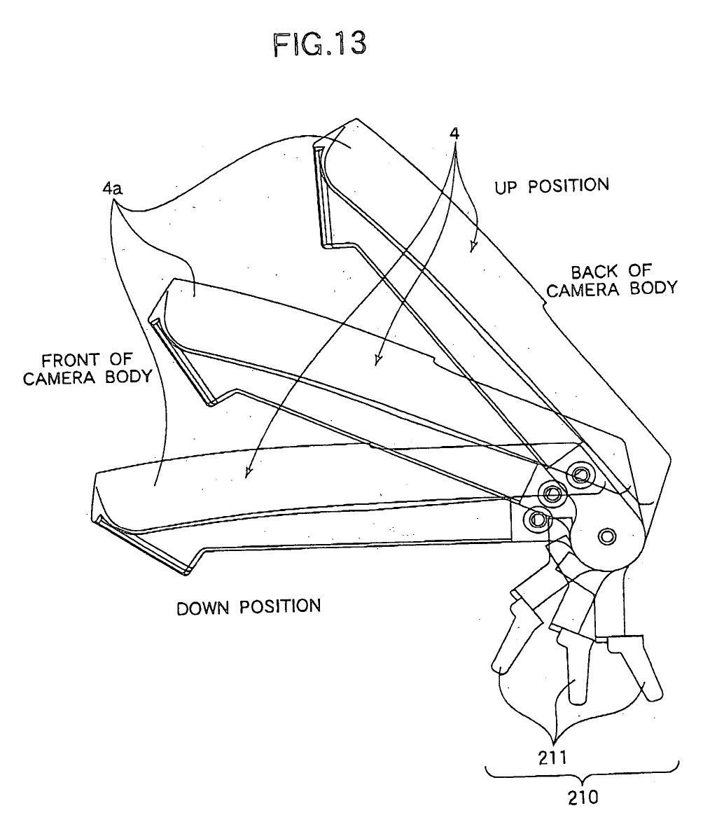

Now, the up-down operation of the flash case 4 is explained. FIGS. 9 through 11 show the positional relationship between the rotating lever 201, the rotating arm 210, and the press spring 220 when the flash case 4 is down, namely when the flash case 4 is received in the upper portion of the camera body 1. When the cam follower 206 is in the area 121b of the cam 121, the cam follower 206 is positioned farthest from the central axis. In other words, the cam follower 206 is positioned at the back side of the camera body 1. In this situation, the rotating lever 201 is positioned at the back side of the camera body 1, resisting against the urging force of the pop-up spring 204, and accordingly the press spring 220 is engaged with the piece 211 of the rotating arm 210 and the rotating arm 210 is positioned at the back side of the camera body 1. Accordingly, the flash case 4 is situated at the down position as shown in FIG. 13.

As described above, the rotating lever 201 is urged by the pop-up spring 204 in the direction from the back side to the front side of the camera body 1, at all times. Namely, the rotating lever 201 is urged towards the front side of the camera body 1, causing the rotating arm 210 to urge the flash case 4 to the up position. Also, the cam follower 206 is urged to be in contact with the cam 121, at all times. Accordingly, if the cam gear 120 keeps rotating in the counterclockwise direction in the situation shown in FIG. 9, the cam follower 206 is moved along the cam 121 and the rotating lever 201 is gradually moved from the back side to the front side of the camera body 1.

In accordance with the movement of the rotating lever 201, the piece 207a of the lever 201 engages with the piece 211 of the rotating arm 210, the arm 210 is rotated so that the piece 211 is moved from the back side to the front side of the camera body 1.

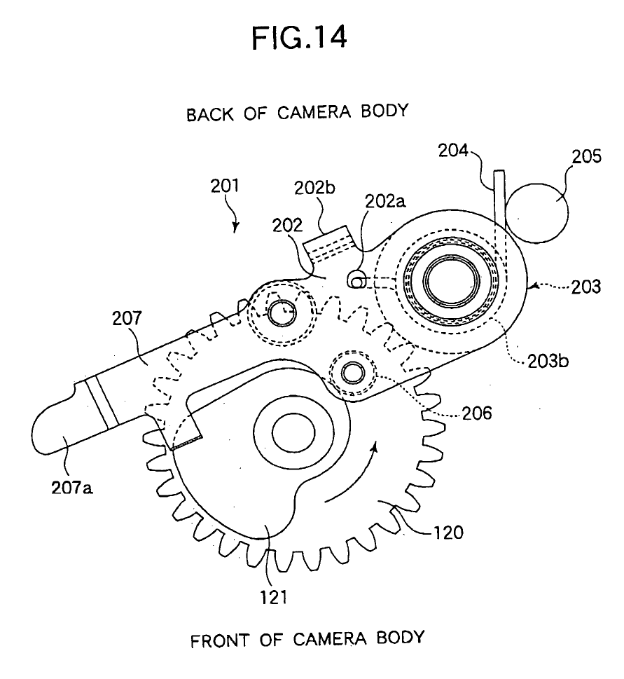

As described above, the flash case 4 is rotated together with the rotating arm 210. Accordingly, the head portion 4a of the flash case 4 begins to gradually rise. When the cam follower 206 is moved to the position shown in FIG. 14, the flash case 4 is positioned at the up position as shown in FIG. 13. Note that, if the flash case 4 is moved from the up-position to the down position by some external force, the rotating arm 210 rotates the rotating lever 201 in the direction against the urging force of the pop-up spring 204, namely in the direction by which the cam follower 206 is parted from the contact surface of the cam 121. Accordingly, the cam 121 is not effected by the external force.

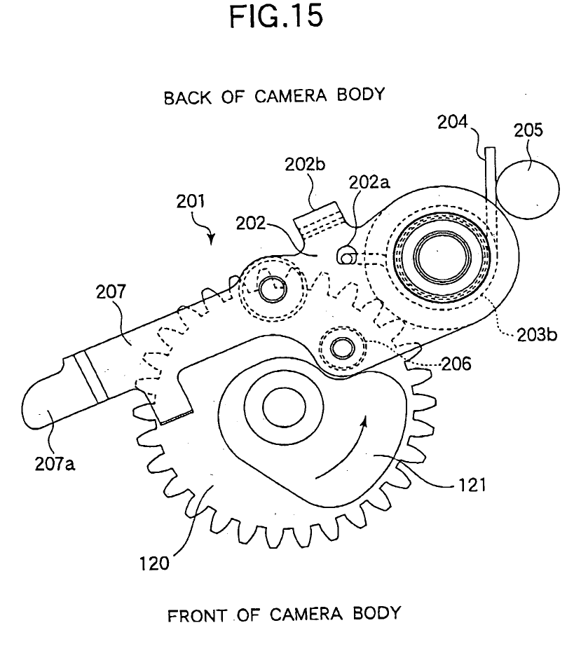

When the first motor 11 keeps rotating in the forward direction, the cam gear 120 in the situation of FIG. 14 is rotated more in the counterclockwise direction. In accordance with the rotation of the cam gear 120, the cam follower 206 is moved along the cam 121 against the urging force of the pop-up spring 204 after being moved to the position of FIG. 15, and then the rotating lever 201 is gradually moved from the front side to the back side of the camera body 1. Accordingly, the flash case 4 is positioned at the down position as shown in FIG. 13. Since the rotating arm 210 is urged by the press spring 220 at all times, the rotating arm 210 is moved to the position at which the arm 210 is mechanically stopped. Therefore, the flash case 4 is prevented from lo stopping at a position above the outer surface of the camera body 1, and the flash case 4 can be precisely positioned at the down position. Further, when a user tries to rise the flash case 4 to the up position by hand, the rotational force of the rotating lever 210 is absorbed by the elastic deformation of the press spring 220. Accordingly, the rotating lever 201 and the cam gear 120 are prevented from being deformed or damaged.

Further, as shown in FIGS. 5 and 6, a main capacitor MC, which is cylindrical, is inserted in the spool 10 which is cylindrical and hollow. The main capacitor MC stores electric charge so that an arc tube (not shown) of the flash light emitting unit 300 can emit light. A substrate E is mounted at the bottom end side of the main capacitor MC. Controlling of the light emitted from the flash light emitting unit 300 and controlling of the charging of the main capacitor MC and so on are performed by the substrate E.

Namely, in the direction along the rotating axis of the spool 10 (in the up and down direction of FIG. 3), the first speed reducing mechanism D1 and the flash substrate E are situated, with the spool 10 between them. The mechanism D1 is situated at the upper end side (the upper plate P of the camera body 1) of the spool 10, and the substrates is situated at the lower end side (the bottom side of the camera body 1) of the spool 10. Note that, the substrate E is omitted in FIG. 5.

In the camera body 1, there are two spaces SS and SP (see FIG. 1) which are separated by a mirror box MB (see FIG. 3) in which a quick return mirror 6 is put. The space SS exists at the side of the spool 10, and the space SP exists at the 15 side of the cartridge room 20. According to this embodiment, the compacts of the flash, including the first speed reducing mechanism D1, the up-down mechanism of the flash case 4, the main capacitor MC, and the substrate E, can be put together in one of the spaces SP and SS.

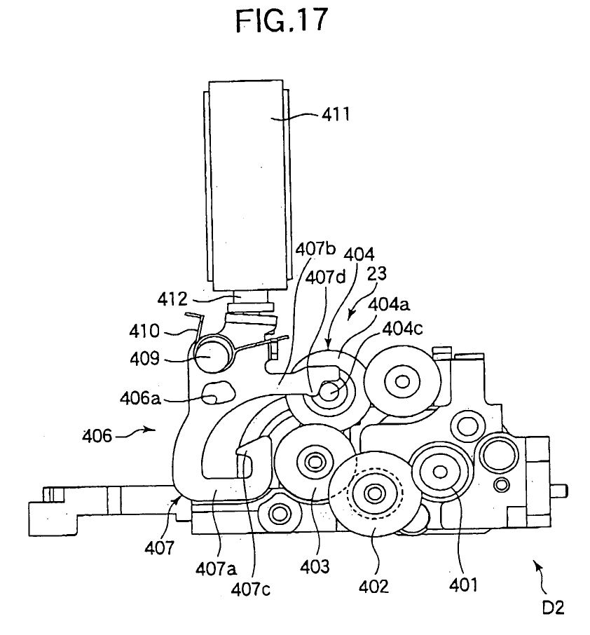

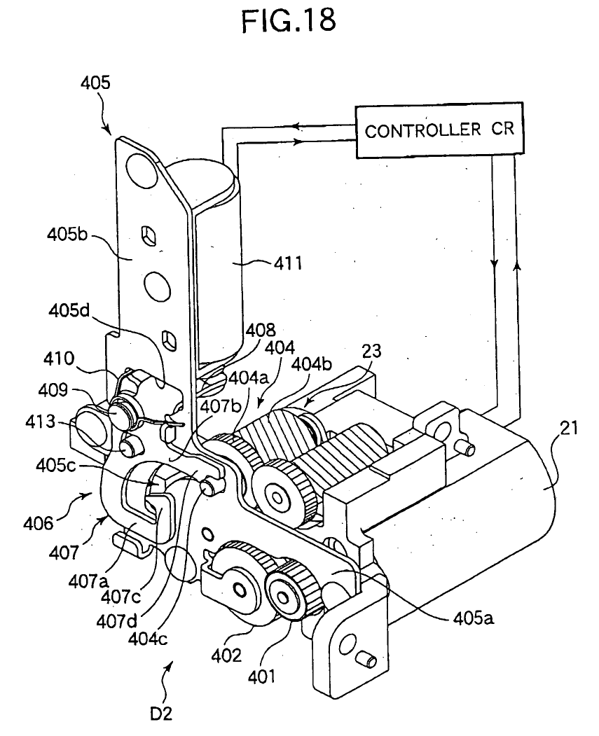

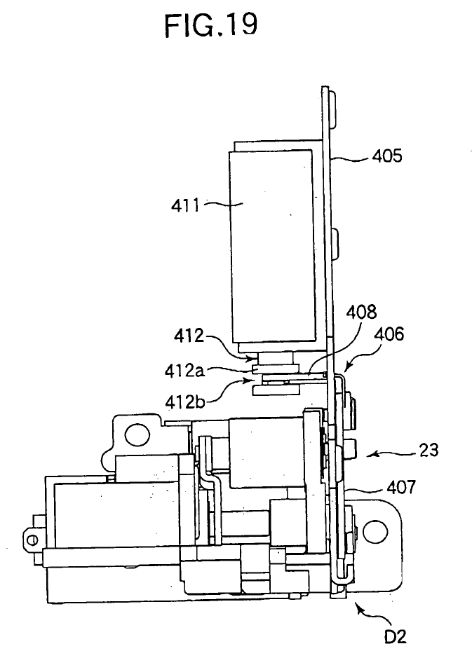

FIG. 16 is an enlarged front view of a second speed reducing mechanism D2. FIG. 17 is an enlarged front view of the mechanism D2, in which some members are omitted. FIG. 18 is a perspective view of the mechanism D2. FIG. 19 is a side view of the mechanism D2, from the left side of FIG. 16. A pinion gear 401 is fixed at a rotating shaft of a second motor 21 (see FIG. 18) A reduction gear 402 is engaged with the pinion gear 401, and a sun gear 403 (see FIG. 17) is engaged with the reduction gear 402. Namely, the rotation of the second motor 21 is transmitted to the sun gear 403, with its speed being reduced through the pinion gear 401 and the reduction gear 402, at a predetermined speed reduction ratio. Further, the rotation of the sun gear 403 is transmitted to a second change mechanism 23 which includes a planet worm 404.

Now, the second change mechanism 23 is explained. As shown in FIG. 18, the planet worm 404 includes a spur gear portion 404a and a worm portion 404b. The spur gear portion 404a is engaged with the sun gear 403 (see FIG. 17) The planet worm 404 is supported so as to be rotatable around the central axis of the sun gear 403. Accordingly, in accordance with the rotation of the sun gear 403, the planet worm 404 is moved in the clockwise or counterclockwise directions in FIGS. 16 and 17 around the central axis of the sun gear 403.

A leading board 405 is provided in front of the spur gear portion 404a. The shape of the board 405 is an L-figure, including two arm portions 405a and 405b. At the corner where the arm portions 405a and 405b cross, a slit 405c, which is arc shaped, is formed. When the planet worm 404 is moved, the central shaft 404c of the planet worm 404 is led by the slit 405c. The planet worm 404 is situated such that the end of the central shaft 404c exists in the slit 405c. When the planet worm 404 is moved in accordance with the rotation of the sun gear 403, the central shaft 404c is led by the slit 405c. Accordingly, the planet worm 404 is smoothly moved. Note that, in FIG. 17, the leading board 405 is omitted in order to clearly show the structure of the above-mentioned gear train.

In the leading board 405, a lever 406 is provided adjacent to the slit 405c. The lever 406 includes a stopper portion 407 and a driven portion 408 (see FIGS. 18 and 19). The stopper portion 407 is parallel to the leading board 405, and the driven portion 408 is perpendicular to the leading board 405. The portions 407 and 408 are unitarily formed. The stop per portion 407 is situated so as to face a plane, of the leading board 405, opposite to a plane on which the above-mentioned gear train is situated. The driven portion 408 is penetrated through a hole 405d of the board 405 and extended to the side at which the above-mentioned gear train is provided. The lever 406 is supported by a supporting shaft 409 provided on the board 405 so as to be rotatable around the shaft 409.

The stopper portion 407 includes two arms 407a and 407b. Stopper pieces 407c and 407d are respectively formed at the end of the arms 407a and 407b. The stopper pieces 407c and 407d are formed in order to stop the movement of the central shaft 404c of the planet worm 404 Namely, when the central shaft 404c is positioned at one end, of the slit 405c, which is adjacent to the cartridge room 20, the stopper piece 407c can stop the movement of the central shaft 404c along the slit 405c. Further, when the central shaft 404c is positioned at another end, of the slit 405c, which is adjacent to the lens mount 5, the stopper piece 407d can stop the movement of the central shaft 404c along the slit 405c. FIGS. 17 and 18 show that the central shaft 404c and the stopper piece 407d are engaged and the movement of the central shaft 404c, namely the movement of the planet worm 404, is restrained. Note that, the details of the positioning of the central shaft 404c are explained later.

A coil spring 410 is wound around the outer surface of the supporting shaft 409. One end of the coil spring 410 is engaged with the hole 405d of the leading board 405, and another end of the coil spring 410 is engaged with a projecting piece formed on the stopper portion 407 of the lever 406. Accordingly, the coil spring 410 urges the lever 406 in the clockwise direction in FIG. 16, at all times.

A solenoid 411 is provided at the arm portion 405b of the leading board 405, being positioned on the plane of the side at which the above-mentioned gear train is provided. A plunger 412 is provided in the solenoid 411. An end 412a of the plunger 412 is formed such that its diameter is larger than that of the other portions of the plunger 412. The end 412a has a groove 412b formed in the circumference direction. As shown in FIG. 19, an end of the driven portion 406 of the lever 406 is positioned in the groove 412b.

The controller CR controls the starting and stopping of the electric supply to the solenoid 411, the starting and s stopping of the rotation of the second motor 21, and further, it controls the rotational direction of the motor 21.

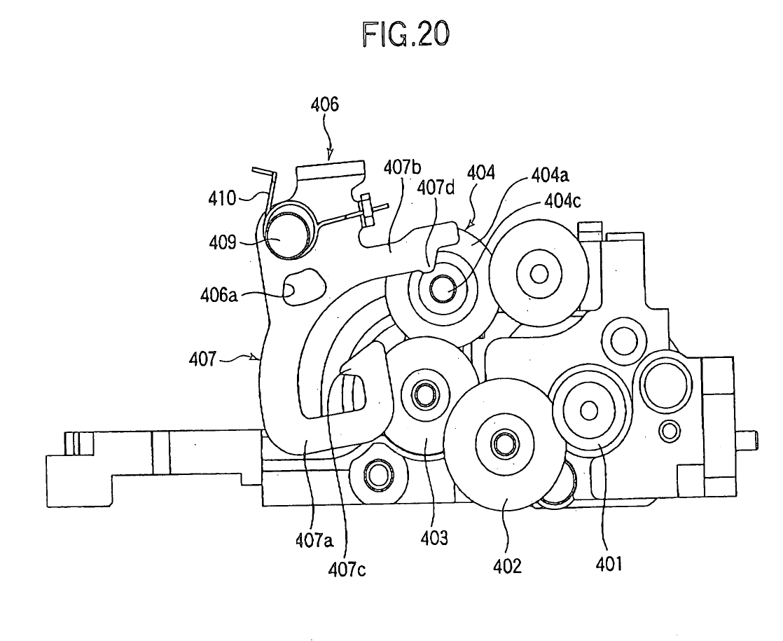

With reference to FIG. 17 and FIGS. 19 through 22, the movement of the planet worm 404 and the positioning of the central shaft 404c in accordance with the movement of the planet worm 404 are explained. Note that, the leading board 405 is omitted in FIGS. 20 through 22 to clearly show the movement of the planet worm 404.

When the solenoid 411 is electrically energized by the control of the controller CR, the plunger 412 is upwardly moved in FIG. 19. In accordance with this movement of the plunger 412, the driven portion 408, of the lever 406, which is in the groove 412b of the plunger 412, is upwardly driven. Accordingly, the lever 406 is rotated around the supporting shaft 409 in the counterclockwise direction in FIG. 17 against the urging force of the coil spring 410. Then, the engagement between the central shaft 404c of the planet worm 404 and the stopper piece 407d is released, as shown in FIG. 20, so that the planet worm 404 becomes movable along the slit 405c of the leading board 405.

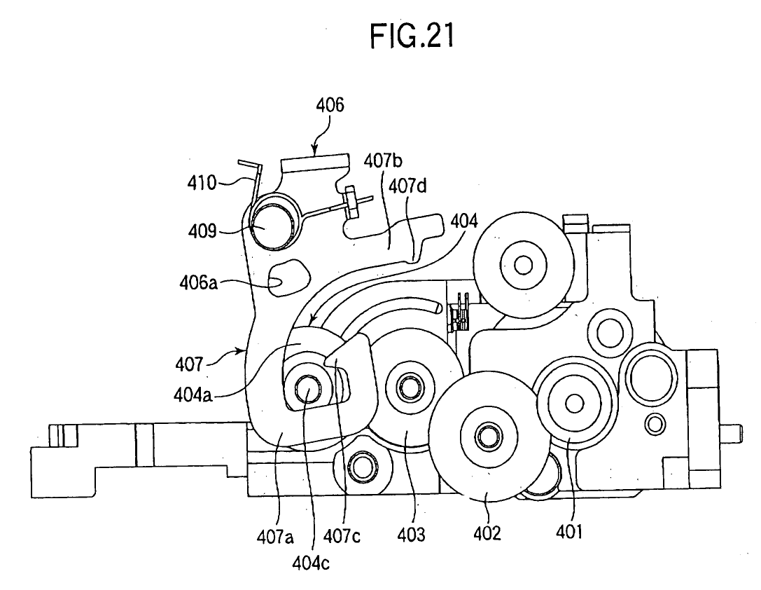

When the second motor 21 is rotated in the reverse direction based on the control of the controller CR in this situation, the pinion gear 401 is rotated in the counterclockwise direction in FIG. 17. The rotation of the pinion gear 401 is transmitted to the sun gear 403 through the speed reduction gear, so that the sun gear 403 is rotated in the counterclockwise direction. Accordingly, the planet worm 404 is moved to a position adjacent to the cartridge room 20 through the spur gear portion 404a which is engaged with the sun gear 403, and the planet worm 404 is positioned as shown in FIG. 21.

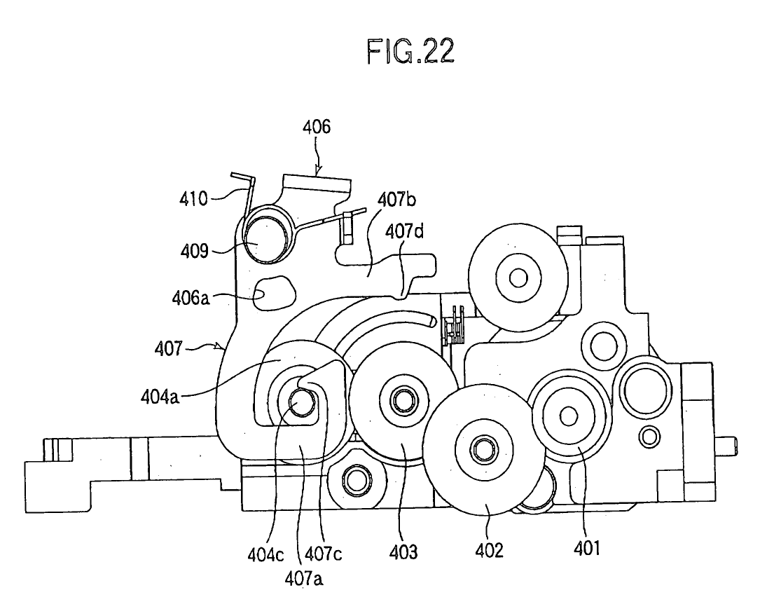

When the solenoid 411 is electrically deenergized based on the control of the controller CR in the situation of FIG. 21, the plunger 412 returns to the original position. In accordance with the movement of the plunger 412, the lever 406 is rotated in the clockwise direction around the supporting shaft 409, and then the stopper piece 407c of the lever 406 and the central shaft 404c of the planet worm 404 are engaged. Accordingly, the planet worm 404 is fixed at the position shown in, FIG. 22.

When the solenoid 411 is electrically energized based on the control of the controller CR in the situation of FIG. 22, the lever 406 is rotated in the counterclockwise direction around the supporting shaft 409 in accordance with the movement of the plunger 412, and the engagement between the stopper 25 piece 407c and the central shaft 404c is released (see FIG. 21). When the second motor 21 is rotated in the forward direction based on the control of the controller CR, and the pinion gear 401 is rotated in the clockwise direction, in this situation, the rotation of the second motor 21 is transmitted to the sun gear 403 through the speed reduction gear 402, and the sun gear 403 is rotated in the clockwise direction. Accordingly, the planet worm 404 is moved to the position adjacent to the lens mount 5 through the spur gear 404a which is engaged with the sun gear 403, so that the planet worm 404 is moved to the position adjacent to the lens mount 5 and positioned as shown in FIG. 20.

When the solenoid 411 is electrically deenergized based on the control of the controller CR in the situation of FIG. 20, the plunger 412 returns to the original position. In accordance with the movement of the plunger 412, the lever 406 is rotated in the clockwise direction around the supporting shaft 409, and then the stopper piece 407d and the central shaft 404c engage. Accordingly, the planet worm 404 is fixed at the position as shown in FIG. 17.

An engaging hole 406a is formed in the lever 406, being adjacent to the central shaft 409. A projecting stopper 413 which is unitarily formed with the leading board 405 is penetrated through the hole 406a (see FIG. 18). Due to the engagement between the stopper 413 and the hole 406a, the lever 406 is prevented from being excessively rotated and moved while the solenoid 411 is electrically energized.

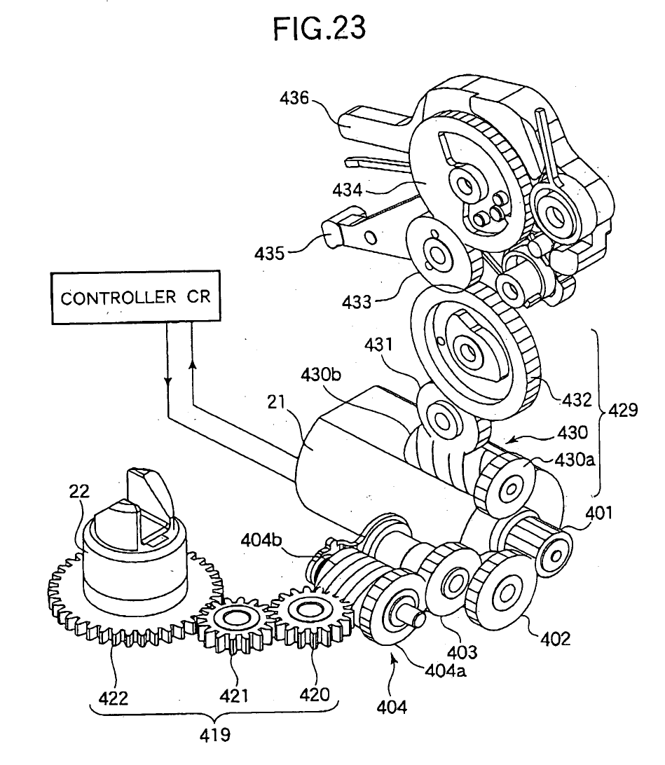

When the planet worm 404 is fixed at the position as shown in FIG. 22, namely at the position adjacent to the cartridge room 20, the worm portion 404b of the planet worm 404 is engaged with a rewind helical gear 420 (whole gear) for rewinding the film, as shown in FIG. 23. A rewind idle gear 421 is engaged with the rewind helical gear 420, and a rewind fork gear 422 is engaged with the rewind idle gear 421. The rewind fork gear 422 is coaxial with a rewind fork 22 of the cartridge room 20. A first gear train 419 is composed of the rewind helical gear 420; the rewind idle gear 421, and the rewind fork gear 422.

The rotation of the second motor 21 is transmitted to the rewind fork 22 through the gear train of the second change mechanism 23 and the first gear train 419, and the rewind fork 22 is rotated. In this embodiment, in the situation where the worm portion 404b of the planet worm 404 is engaged with the rewind helical gear 420, the second motor 21 is controlled by the controller CR so as to be rotated only in the counterclockwise direction. In other words, while the worm portion 404b is engaged with the rewind helical gear 420, the controller CR controls the drive of the second motor 21 such that the rewind fork 22 is rotated only in the direction of rewinding the film.

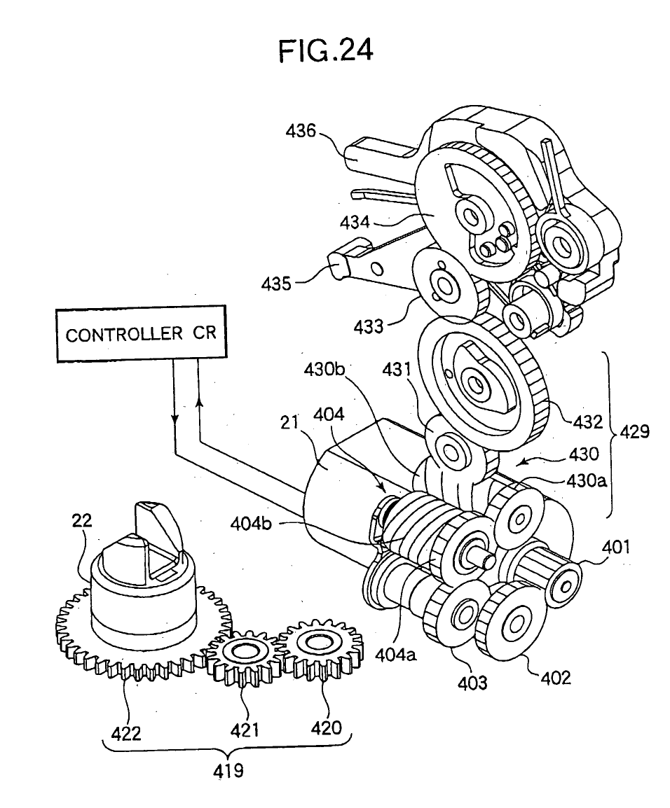

When the planet worm 404 of the second change mechanism 23 is fixed at the position as shown in FIG. 17, namely the planet worm 404 is-positioned adjacent to the lens mount 5, the spur gear portion 404a of the planet worm 404 is engaged with a spur gear portion 430a of a charge worm gear 430 of a second gear train 429, as shown in FIG. 24. The second gear train 429 includes the charge worm gear 430, a gear 431, a diaphragm control gear 432. The gear 431 is engaged with a worm wheel portion 430b of the charge worm gear 430, and the diaphragm control gear 432 is engaged with the gear 431. A diaphragm control mechanism (not shown) is connected with the diaphragm control gear 432. The forward rotation of the second motor 21 is transmitted to the diaphragm control mechanism through the above-mentioned gear train of the second speed reducing mechanism D2 and the second gear train 429.

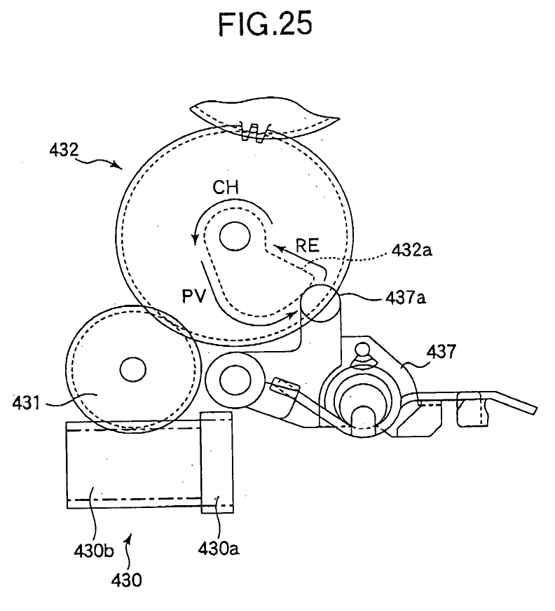

An idle gear 433 is engaged with the diaphragm control gear 432, and a gear 434 is engaged with the idle gear 433. After being transmitted to the gear 434 through the gear train of the second speed reducing mechanism D2, and the second gear train 429, and the idle gear 433, the forward rotation of the second motor 21 is transmitted to a shutter charge lever 435 and a mirror drive lever 436. Accordingly, by rotating the second motor 21 in the forward direction in the situation where the planet worm 404 is fixed at the position shown in FIG. 17, the shutter and the quick-return-mirror are driven. FIG. 25 is a front view which partially shows the gear train shown in FIG. 24. A rotating cam 432a is formed on a plane portion of the diaphragm control gear 432. The diaphragm control lever 437 includes a cam follower 437a which is moved in accordance with the movement of the rotating cam 432a. In the photographing (release) operation, the second motor 21 is rotated in the forward direction based on the controller CR (see FIG. 18), in the situation where the planet worm 404 is fixed at the position as shown in FIG. 17. Accordingly, the diaphragm control gear 432 is rotated in the clockwise direction in FIG. 25.

In the photographing operation, the rotation of the second motor 21 is controlled such that the cam follower 437a is moved along an area RE of the rotating cam 432a. The diaphragm control lever 437 is driven in accordance with the 5 movement of the cam follower 437a, and the diaphragm is stopped down. Then, the quick return mirror 6 is raised, and the shutter is driven.

After the driving of the shutter is finished, the second motor 21 is rotated more in the forward direction based on the control of the controller CR, the diaphragm control gear 432 is rotated more in the clockwise direction, and then the gear 432 returns to the position shown in FIG. 25.

Note that, while the cam follower 437a is in contact with the area CH during the rotation of the gear 432, the shutter charge is carried out and the quick return mirror 6 returns to its original position. After the cam follower 437a passes through an area next to the area CH, the diaphragm which is stopped down is opened. Namely, by rotating the diaphragm control gear 432 one time, the photographing operation and shutter charge are carried out and the shutter and the diaphragm are prepared for the next photographing.

When the second motor 21 is rotated based on the control of the controller CR in the situation where the planet worm gear 404 is positioned as shown in FIG. 17, the diaphragm control gear 432 is rotated in the counterclockwise direction in FIG. 25, the cam follower 437a is moved along the rotating cam 432a. During the preview operation, the rotation of the second motor 21 is controlled such that the cam follower 437a is moved along an area PV of the rotating cam 432a. In accordance with the movement of the cam follower 437a along the area. PV, the diaphragm control lever 437 is driven, so that the diaphragm is controlled. After the preview operation, the second motor 21 is rotated and the cam follower 437a is moved back to the position shown in FIG. 25.

A cylindrical cam (not shown) is formed on the plane portion of the gear 434. The radius of the cylindrical cam is fixed and the cam is formed such that when the gear 434 is rotated at a predetermined rotating angle, the positions of the levers 435 and 436 are not changed. The controller CR controls the rotation angle of the gear 434 based on the output of a sensor unit which includes a brush (not shown) formed on the gear and a code plate which is positioned so as to face the brush. On the other hand, the cam 432a of the gear 432 is formed such that the lever 437 is driven in the above-mentioned manner. Accordingly, when the planet worm 404 is positioned as shown in Fig, 17 and the second motor 21 is rotated in the reverse direction while controlling the rotation angle of the gear 434 at the predetermined angle, the shutter and the quick return mirror 6 are not driven, and only the control of the diaphragm is performed. Namely, keeping the mirror 6 down, only the control of the diaphragm is performed. Accordingly, confirmation of the size of the opening of the diaphragm through the finder, is possible.

As described above, according to this embodiment, the first motor 11 is used as the driving source of the spool 10 and the up-down operation of the flash case 4. And the first speed reducing mechanism D1, which transmits the rotation of the first motor 11 to the spool 10 reducing its speed, is provided at the upper side of the spool 10. Conventionally, in the camera body of a single-lens reflex camera, an inversion optical system, for example a penta prism, is provided at the upper side of the mirror box, and unused spaces exist around the penta prism. However, according to this embodiment, as the mechanism D1 is provided at the upper side of the spool 10, the mechanism D1 is used not only for winding the film but also for driving the flash, and the unused spaces are efficiently used. Accordingly, the camera body can be compact.

In this embodiment, the winding of the film is carried out by the first motor 11, and the rewinding of the film is carried out by the second motor 21. Accordingly, it is not necessary~to provide a gear train for feeding the film at the bottom of the camera body 1. The flash substrate E is provided at the bottom of the spool 10 in the space where conventionally the gear train is provided. The area where the flash substrate E is set can be relatively compact, and the thickness of the substrate E can be less than that of the gear train. Accordingly, the length of the camera body 1 in the lengthwise direction can be short.

Further, in this embodiment, the main capacitor MC is provided in the spool 10. Namely, with the first speed reducing mechanism D1, the compacts for the flash (the up-down operating mechanism of the flash, the main capacitor MC, and the substrate E) are put in the space-SS which is at the side of the spool 10 in the camera body 1. Accordingly, the camera body 1 can be compact without rendering the structure in the camera body 1 complex.

The forward rotation of the first motor 11 is used for the up-down operation of the flash light emitting unit 300, and the reverse rotation of the first motor 11 is used for winding of the film. Further, when the planet worm 404 is positioned adjacent to the cartridge room 20 and the worm portion 404b is engaged with the helical gear 420, the reverse rotation of the second motor 21 is used for rewinding of the film. When the planet worm 404 is positioned adjacent to the lens mount 5, the worm portion 404b is engaged with the spur gear 430a of the charge worm gear 430, the reverse rotation of the second motor 21 is used for driving the diaphragm in the preview, and the forward rotation is used for driving of the mirror 6, the shutter, and the diaphragm in the photographing operation. Namely, the first and second motors 11 and 21 are respectively used as the driving source for a plurality of operations. Accordingly, the number of driving sources can be restrained, and the camera can be made compact.

According to the present invention, the driving source for winding the film is used for the up-down operation of the flash, and the speed reducing mechanism which transmits the driving force is provided at the upper side of the spool. Therefore, the unused space at the upper side of the camera can be effectively used, so that the camera can be wholly compact.

The present disclosure relates to subject matter contained in Japanese Patent Application No. 2003-039946 (filed on Feb. 18, 2003) which is expressly incorporated herein, by reference, in its entirety.

1. A camera comprising:
a first motor which is used for a driving source of an up-down operating mechanism of a case in which a flash is provided, and a driving source for winding a film;
a first speed reducing mechanism which transmits a rotation of said first motor, reducing its rotating speed; and
a spool which is rotated by transmitting the rotation of said first motor through said first speed reducing mechanism;
wherein said first speed reducing mechanism is situated at the upper side of said spool.

2. The camera according to claim 1, wherein a substrate for controlling said flash is provided at the lower side of said spool, and a capacitor which is mounted on said substrate is penetrated through said spool.

3. The camera according to claim 1, wherein said first speed reducing mechanism includes a first change mechanism which changes transmission paths of the rotation of said first motor such that a rotational force, of said first motor, in a first direction is transmitted to said spool, and a rotational force, of said first motor, in a second direction opposite to said first direction is transmitted to said up-down operating mechanism.

4. The camera according to claim 3, wherein said first change mechanism includes:
a pinion gear which is fixed at an output shaft of said first motor;
a speed reducing gear train;
a sun gear to which the rotation of said pinion gear is transmitted through said speed reducing gear train; and
a planet gear which is engaged with said sun gear,
wherein when said first motor is rotated in said first direction, said planet gear is moved so as to be engaged with a gear which is engaged with a connecting gear which transmits a rotational movement to said spool,
and when said first motor is rotated in said second direction, said planet gear is moved so as to be engaged with a cam gear for moving a follower pin which drives said up-down operating mechanism.

5. The camera according to claim 1, further comprising:
a second motor which is used as a driving source for rewinding the film; and
a second speed reducing mechanism which transmits a rotation of said second motor reducing its rotating speed;
wherein said second motor and said second speed reducing mechanism are provided at the bottom of said camera, in a space at a side of said mirror, which is opposite to a side of said mirror closest to said spool.
